(19) United States
(12) Patent Application Publication
(10) Pub. No.: US 2016/0350817 A1
(43) Pub. Date: Dec. 1, 2016

(54) SYSTEM FOR TRACKING DONOR INFLUENCE IN CHARITABLE TRANSACTIONS

(71) Applicant: Blackbaud Inc., Charleston, SC (US)

(72) Inventors: Matthew Garbarino, Charleston, SC (US); Brian Swick, Asheville, NC (US)

(73) Assignee: Blackbaud Inc., Charleston, SC (US)

(21) Appl. No.: 15/165,516

(22) Filed: May 26, 2016

Related U.S. Application Data
(60) Provisional application No. 62/167,620, filed on May 28, 2015.

(51) Int. Cl. G06Q 30/02; G06F 17/30; H04L 29/08

(52) U.S. Cl. CPC G06Q 30/0279; H04L 67/02; G06F 17/30864; G06Q 50/01

(57) ABSTRACT

A system for tracking donor influence in a charitable fundraising campaign by generating unique URLs in response to a fundraising transaction, and associating web page metadata with donors in a transaction database is described. Embodiments of the present disclosure provide a system for generating unique links for online donation forms containing embedded GUIDs, and provisioning GUID data to a transaction database to track the relationships between donors across database nodes, and calculate an aggregate impact of a referring donor's online link sharing efforts across a network.

### RELATED APPLICATIONS

This patent is related to U.S. patent application Ser. No. 62/167,620 by Matthew Garbarino and Brian Swick, filed on May 28, 2015 and entitled “SYSTEM FOR TRACKING DONOR INFLUENCE IN CHARITABLE TRANSACTIONS,” assigned to the assignee of the present invention.

### FIELD

The present disclosure relates to improvements in the technical field of internet-based charitable transactions; in particular, a system for tracking donor influence across a network of charitable transactions by embedding a globally unique identifier in an online donation form, and tracking root-descendent relationships over the Internet through embedded webpage metadata.

### BACKGROUND

Various embodiments of the present disclosure relate to systems for online transaction processing for charitable organizations. The practice of non-profit organizations and charities soliciting donations over the Internet is well-established. The use of online fundraising computer applications and transaction gateways is an important tool for organizations to reach a wide audience of potential donors, and transact donations without live donor interaction. The success of online fundraising campaigns is often dependent on the amount of online marketing and advertising the organization has committed to the campaign, and/or the size of the organization's email marketing list.

It is a well-established practice for non-profit organizations to analyze channel statistics to gather donor demographic data. As millennials continue to emerge as an important demographic of donors, non-profit organizations are continuously placing more emphasis on online fundraising as an important channel strategy for this group. “Millennials” are generally defined as individuals being born between the early 1980s and the early 2000s. This demographic is statistically more likely to have larger online social networks than other demographics (such as Gen X or Baby Boomers), and consume more of their content online. Organizations have begun to more accurately identify key donor behavior in this group. For example, millennials tend to engage with causes to help other people rather than institutions; millennials are influenced by the decisions and behaviors of their peers; and, millennials prefer to perform smaller actions before fully committing to a cause.

The millennial demographic presents a significant opportunity for non-profit organizations in online fundraising campaigns because of the potential reach of millennials' social networks. The practice of “sharing” information over social platforms is well-established. It is common practice for organizations to encourage link sharing over social platforms or email to drive traffic to a fundraising campaign web page. However, the success of social sharing as a way to drive donor engagement is often elusive or unpredictable. What is needed, therefore, is a system to track and report the impact of individual donors to a charitable campaign.

Through applied effort, ingenuity, and innovation, Applicant has identified a number of deficiencies and problems associated with the tracking root-branch relationships fundraising transactions, and displaying those relationships through one or more webpages. Applicant has developed a solution that is embodied by the present disclosure, which is described in detail below.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible and/or non-transitory computer readable media (such as, to name but a few examples, optical media, magnetic media, and/or the like).

An object of the present disclosure is a novel system for driving donor engagement in online fundraising campaigns.

Another object of the present disclosure is a novel system for tracking peer-to-peer influence in online fundraising campaigns.

Another object of the present disclosure is an improvement to online charitable transaction technology to enable tracking a donor's aggregate impact on an online fundraising campaign through sharing of a uniform resource locator.

Yet another object of the present disclosure is an improvement to online charitable transaction technology for embedding globally unique identifiers (GUIDs) in a web page for processing charitable donations, and associating said GUIDs with transaction data in a database.

Specific embodiments of the present disclosure include a method of embedding a globally unique identifier in a web form for the purpose of tracking relationships between charitable transactions across a network. The method comprises providing, with a computer system, a web page to a web browser in response to a request from a donor device, the web page being associated with a charitable fundraising campaign and containing one or more form elements to input payment data from the donor device, the computer system having an application server and a transaction database; receiving, with the application server, payment data submitted from the donor device through the web page; transmitting, with the application server, payment data to a payment gateway, the payment gateway executing a transaction for a charitable donation and provisioning transaction data to the application server; generating, with the computer system, a globally unique identifier; associating, with the computer system, the transaction data with the globally unique identifier; storing, with the computer system and in the transaction database, the transaction data and the globally unique identifier, the transaction database storing the transaction as a root node and assigning the globally unique identifier as a primary key to the root node; embedding, with the application server, the globally unique identifier in a uniform resource locator, the uniform resource locator configured to access a webpage associated with the charitable fundraising campaign and containing one or more form elements to input payment data from a branch donor; and, communicating, with the computer system, a web page to the donor device, the web page containing a transaction confirmation and the uniform resource locator.

This embodiment may further include providing, with the computer system, a web page to a branch donor device, the web page having metadata containing the uniform resource locator providing, with the computer system, a web page to a web browser in response to a request from the branch donor device, the web page being associated with the charitable fundraising campaign and containing one or more form elements to input payment data from the branch donor device; receiving, with the application server, payment data and metadata submitted from the branch donor device through the web page; and, transmitting, with the application server, payment data to a payment gateway, the payment gateway executing a transaction for a charitable donation and provisioning transaction data to the application server; generating, with the computer system, a branch globally unique identifier; associating, with the computer system, the transaction data with the globally unique identifier and the branch globally unique identifier; storing, with the computer system and in the transaction database, the transaction data, the globally unique identifier and the branch globally unique identifier, the transaction database storing the transaction as a child node to the root node and assigning the branch globally unique identifier as a foreign key to the child node; embedding, with the application server, the branch globally unique identifier in a uniform resource locator, the uniform resource locator configured to access the webpage associated with the charitable fundraising campaign; and, providing, with the computer system, a web page to the branch donor device, the web page containing a transaction confirmation and the uniform resource locator; providing, with the computer system, a web page to a plurality of sub-branch donor devices, the web page having metadata containing the branch uniform resource locator, the web page containing one or more form elements to input payment data from the plurality of sub-branch donor devices.

This embodiment may further include receiving, with the application server, payment data and metadata submitted from the plurality of sub-branch donor devices through the web page; executing, with the application server, a plurality of transactions for charitable donations and provisioning transaction data to the application server for the plurality of transactions; generating, with the computer system, a sub-branch globally unique identifier for each transaction in the plurality of transactions; associating, with the computer system, the transaction data with the branch globally unique identifier and the sub-branch globally unique identifier for each transaction in the plurality of transactions; storing, with the computer system and in the transaction database, the transaction data for each transaction in the plurality of transactions, the branch globally unique identifier and the sub-branch globally unique identifier, the transaction database storing each transaction in the plurality of transactions as a descendant node to the child node and assigning the sub-branch globally unique identifier as a foreign key to the descendant node; querying, with the application server, the transaction database to aggregate transaction data across child nodes and descendant nodes of the root node, and calculating an aggregate transaction value across each node; and, communicating, with the computer system, the aggregate transaction value for a specific node to a social network web platform.

A further specific embodiment of the present disclosure includes an apparatus or a computer system comprising one or more processors, the one or more processors defining an application server; a transaction database operatively associated with at least one of the one or more processors; a set of instructions executable by at least one of the one or more processors, to cause the at least one of the one or more processors to perform one or more operations. The set of instructions comprises instructions for providing a web page to a web browser in response to a request from a donor device, the web page being associated with a charitable fundraising campaign and containing one or more form elements to input payment data from the donor device; instructions for receiving payment data submitted from the donor device through the web page; instructions for transmitting payment data to a payment gateway, the payment gateway executing a transaction for a charitable donation and provisioning transaction data to the application server; instruction for generating, with a globally unique identifier generation engine, a globally unique identifier; instructions for associating the transaction data with the globally unique identifier; instructions for storing in the transaction database, the transaction data and the globally unique identifier, the transaction database storing the transaction as a root node and assigning the globally unique identifier as a primary key to the root node; instructions for embedding, with the application server, the globally unique identifier in a uniform resource locator, the uniform resource locator configured to access a webpage associated with the charitable fundraising campaign and containing one or more form elements to input payment data from a branch donor; and, instructions for communicating a web page to the donor device, the web page containing a transaction confirmation and the uniform resource locator.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a diagrammatic flow chart of the overall system arrangement, in accordance with various embodiments;

FIG. 2 is a flow chart of the system process flow, in accordance with various embodiments;

FIG. 3 is a schematic diagram of the application server logic, in accordance with various embodiments;

FIG. 4 is an illustration of a root donor input webpage according to an embodiment;

FIG. 5 is an illustration of a transaction confirmation webpage according to an embodiment;

FIG. 6 is an illustration of a social platform share webpage according to an embodiment;

FIG. 7 is an illustration of a branch donor input webpage according to an embodiment;

FIG. 8 is an illustration of a transaction confirmation webpage according to an embodiment;

FIG. 9 is an illustration of a donor influence report according to an embodiment;

FIG. 10 is a schematic diagram of a donor influence map;

FIG. 11 is a process flow diagram of a method of embedding a GUID in a URL for a root transaction, in accordance with various embodiments;

FIG. 12 is a process flow diagram of a method of embedding a GUID in a URL for a branch transaction, in accordance with various embodiments;

FIG. 13 is a process flow diagram of a method of querying a database to determine an aggregate transaction value across selected nodes, in accordance with various embodiments;

FIG. 14 is a generalized schematic diagram illustrating a computer system, in accordance with various embodiments; and,

FIG. 15 is a block diagram of a networked system of computers, which can be used in accordance with various embodiments

### DETAILED DESCRIPTION

Embodiments of the present disclosure relate to systems for tracking the aggregate influence of an individual donor in an online fundraising campaign. According to an embodiment, a donor accesses a web form containing fields for donor and payment data. The donor enters information such as donor name, address and contact information, and credit card information into the web form. The donor submits the information through the webpage and is directed to a confirmation page with a transaction summary and a link to share the webpage containing the donation form with other potential donors via social platforms or email. The link contains a globally unique identifier (GUID) embedded in the uniform resource locator (URL) or metadata of the webpage such that donors accessing the donation form from the shared link can be tracked and associated with the donor who shared the link. A unique link containing an embedded GUID is generated by an application server after each transaction, such that the donor can share the link with other potential donors, and the system can track donors accessing the donation form from the unique link. Embodiments of the present disclosure provide a system for creating unique links for online donation forms containing embedded GUIDs, and using GUID data to track the relationships between donors; as well as aggregate impact of a referring donor. Through applicant's applied effort and ingenuity, the present invention contributes to useful improvements in the technical field of online fundraising campaigns, web forms, and tracking and reporting of online transactions.

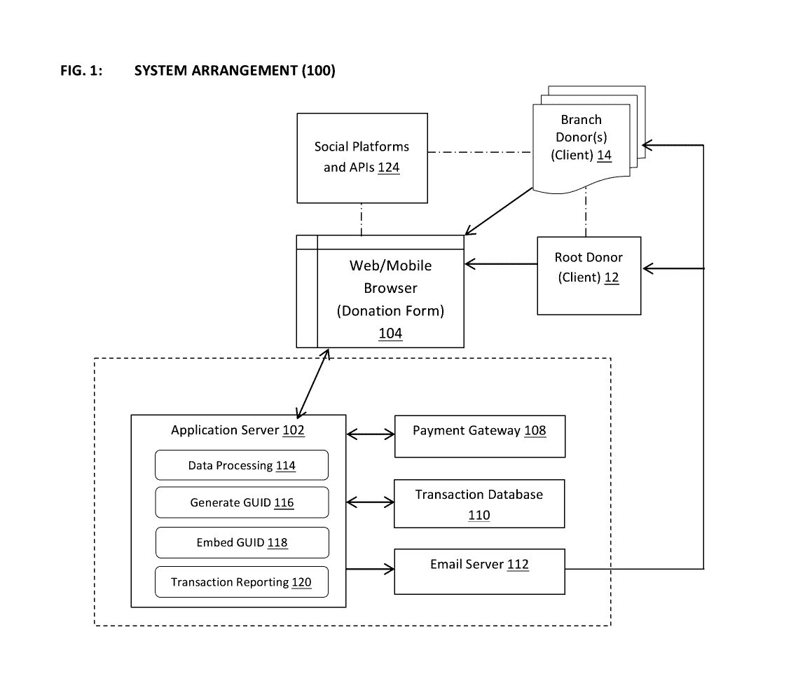

Referring now to FIG. 1, a diagrammatic flow chart of a system arrangement of the present disclosure is shown. According to an embodiment, a system 100 enables tracking a donor's aggregate impact on an online fundraising campaign. An application server 102 is operable to execute logic to execute an algorithm to generate a GUID 118 and embed the GUID in a uniform resource identifier (URL) and/or metadata 116 of a campaign webpage containing a donation form. A root donor 12 may access a campaign webpage by making a request to a web or mobile browser 104 via a client device such as a smartphone or computer. Webpage content containing a GUID and donation form elements may be communicated to browser 104 to be displayed on client device. Root donor 12 submits form data, including payment data, to application server 102 by initiating a push request from browser 104. Application server 102 is operable to execute business logic including connectivity with transaction database 110 and communication with services such as payment gateway 108 and email server 112. Upon receiving form data from browser 104, application server 102 communicates payment credentials to payment gateway 108 for processing. Payment gateway 108 may also be internal to application server 102. Transaction results from payment gateway 108 are communicated back to application server 102. Application server 102 generates a new GUID 118 in response to a successful transaction result from payment gateway 108, and embeds GUID 116 in a unique URL for the campaign webpage containing the donation form. Application server 102 processes transaction data, form data and GUID data 114 for storage in transaction database 110. Transaction database 110 may be relational or non-relational and may have multi-region ability and read-only slave support to distribute the load on database requests coming from application server 102. Transaction database 110 stores relationship between GUID data communicated from browser (root GUID) and GUID data generated by application server 102 in response to transaction confirmation (branch GUID). Transaction database 110 also associates form data and transaction data to root and branch GUIDs. Application server 102 may also be connected to separate bucket-type storage for static files such as images, PDFs, java script, HTML, CSS, and/or any non-database-driven content. Static content stored in static storage may be delivered to client browser via a content delivery network. The content delivery network may facilitate edge-cache to serve static content without requesting the same resource from static storage.

Upon successful completion of business logic and data processing, application server 102 is operable to deliver confirmation page content to browser 104 including a summary of the transaction data and the URL containing the embedded branch GUID. Root donor 12 may share the branch URL with a branch donor 14 by posting the branch URL on a social platform via the platform's sharing API 124, or emailing the branch URL to a branch donor 14 through an email service. Branch donor 14 makes a request to browser 104 to access branch URL. The campaign webpage containing the donation form is displayed within the browser. Scripting on the branch page displays transaction aggregate from transaction database 110 on the webpage. Branch donor 14 submits form data, including payment data, to application server 102 by initiating a push request from browser 104. Application server 102 executes business logic and communication protocols according to the same routines as described in the root donor transaction above. GUID data from the branch transaction is associated with the root transaction in transaction database 110, such that the database associates the root GUID as the parent transaction to the URL accessed by the branch donor. Application server 102 generates a sub-branch GUID embedded in a unique URL, using the same protocols as that of root GUID described above. Each branch donor 14 is assigned a unique GUID and sub-branch URL. Branch donor 14 may share sub-branch URL in the same manner as described above for branch URL. Subsequent sub-branch donors may submit donations according to the same protocols as branch GUID, such that transaction database 110 is operable to aggregate the progeny of branch and sub-branch GUIDs resulting from each originating GUID. Transaction database 110 stores the originating GUID and the transaction GUID in the database to define transaction relationships and create a new branch for subsequent transactions originating from the new transaction GUID.

Application server 102 is further operable to execute logic for transaction reporting 120. Transaction reporting queries the database for an individual donor and assembles an aggregate of all transactions originating from the donor's GUID. Email server 112 is responsible for sending email containing a transaction report to the donor when instructed by the application server in response to an email send condition. Email server 112 also tracks email delivery including bounce statistics and open-tracking. Transaction report email includes donor influence aggregate and a copy of the donor's URL for sharing.

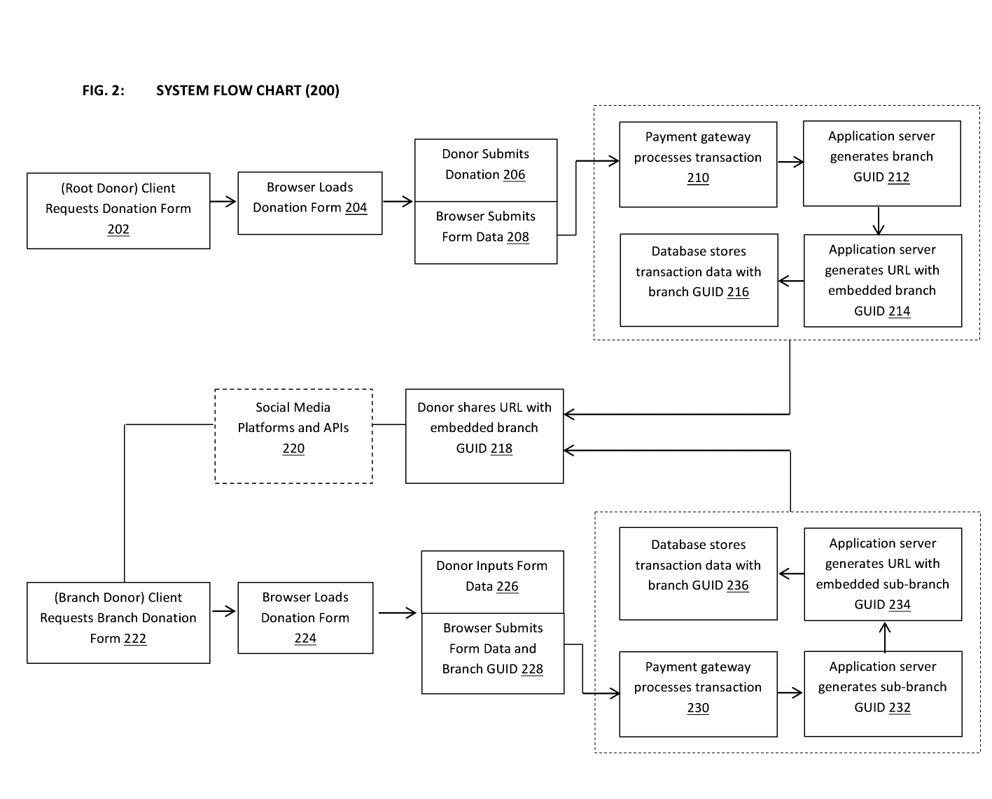

FIG. 2 is a flow chart of the system process flow 200 according to the system arrangement of FIG. 1. According to an embodiment, an online fundraising transaction system enables tracking the aggregate influence of individual donors in an online fundraising campaign. The systems enables tracking aggregate influence by generating unique URLs for each donor contributing to the campaign, embedding a GUID in a webpage containing a donation form, and defining the relationships between root GUIDs and branch GUIDs in a transaction database. A root donor requests a donation form from a client device 202. A browser loads donation form 204 on client device. The donor submits donation form 206 through browser, and browser submits form data to application server 208. Form data is communicated to payment gateway to process donation transaction 210. Transaction results are communicated from payment gateway to application server. Application server generates branch GUID in response to a successful transaction result 212. Application server generates URL for branch donation form with embedded branch GUID 214. Application server communicates to database to store transaction data and GUID 216. Application server communicates transaction confirmation page to donor with embedded branch GUID. Donor shares URL with embedded branch GUID 218 through social media platforms 220 or email with branch donors.

Branch donors request branch donation form from client device 222. Browser loads branch donation form 224. Branch donor submits branch donation 226 using donation form. Browser communicates transaction data from donation form and branch GUID metadata to application server 228. Form data is communicated to payment gateway to process donation transaction 230. Transaction results are communicated from payment gateway to application server. Application server generates sub-branch GUID in response to a successful transaction result 232. Application server generates URL for sub-branch donation form with embedded sub-branch GUID 234. Application server communicates to database to store transaction data and branch GUID, and associates branch donation data with root GUID metadata 236. Application server communicates transaction confirmation page to branch donor with embedded branch GUID. Branch donor shares URL with embedded branch GUID 218 through social media platforms 220 or email with sub-branch donors. This process flow may continue according to these logic steps with each successive sub-branch donor.

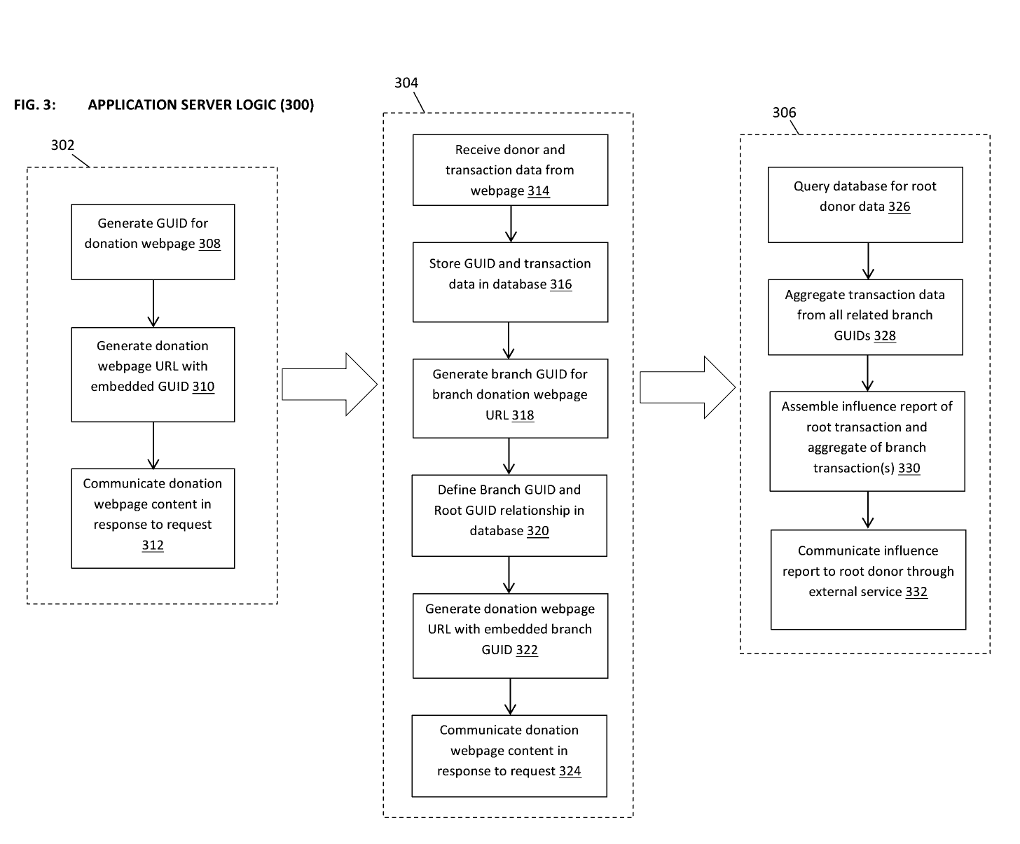

FIG. 3 is a schematic diagram of application server logic 300. Routines for generating a unique link 302, processing a transaction 304, and assembling a donor influence report 306 are described. According to an embodiment, application server executes a GUID algorithm to generate a unique identifier for a webpage containing a donation form 308. The GUID algorithm may apply various implementations of the universally unique identifier (UUID) standard, or may apply other sequential or pseudo-random methodologies. For each GUID created, application server creates a unique URL containing the GUID 310. The unique URL locates the resource associated with the donation page. Static webpage content (such as images, PDFs, java script, HTML, CSS, and/or any non-database-driven content) may be identified as a new resource in the system for each GUID. Definition of each GUID in the system as a unique resource enables the system to associate form data with each GUID, while reapplying static elements of the webpage containing the donation form to each unique resource. The URL contains protocol for retrieving the resource such that the application server communicates the donation page to a browser in response to a request 312. Application server may execute protocols to communicate with static storage and/or a content delivery network to transfer the webpage content.

Application server executes logic to process a transaction submitted from the donation webpage 304. Application server receives donor information from webpage and transaction data from payment gateway 314. Application server communicates donor information, transaction data, and GUID data to the database, which stores donor and transaction data, and GUID data 316. Application server executes instructions to create a branch GUID 318 and a new URL containing the branch GUID 322. The branch GUID is communicated to the database, and stored as a new object in database 320. Each GUID in the database may have many branch GUIDs, representing new branches of donors accessing the donation form from the URL associated with the GUID. Application server communicates webpage content associated with each unique URL according to requests by a browser 324.

Application server executes logic to assemble an influence report containing an aggregate of all donations sharing a branch relationship to a donor 306. Application server initiates a query to the database for an individual donor 326. GUID data for that donor is queried to calculate the aggregate of all transactions having a GUID relationship with the queried donor 328. Application server may execute instructions to assemble donor data and aggregate value with static report content to create an influence report, such that a donor may be presented with the aggregate impact his or her linking sharing has had on total charitable contributions 330. Application server may assemble the data and content as a static file such as a PDF. The influence report may be communicated to the queried donor through an external service such as an email server for access by the donor 332.

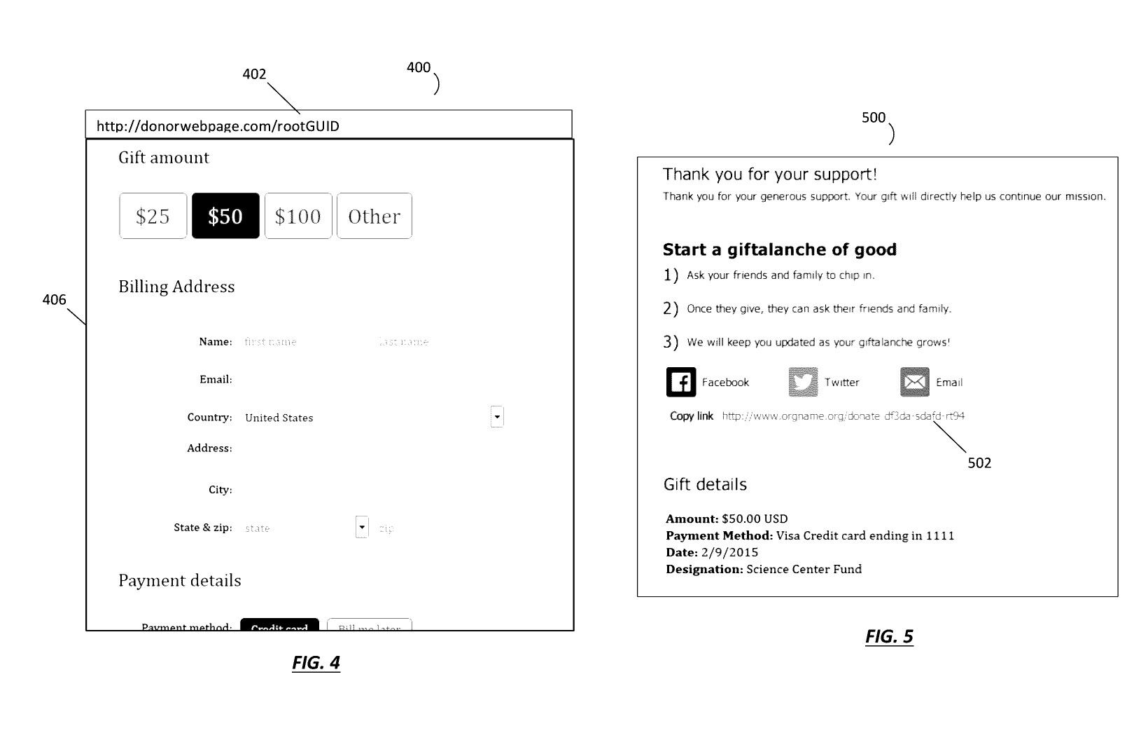

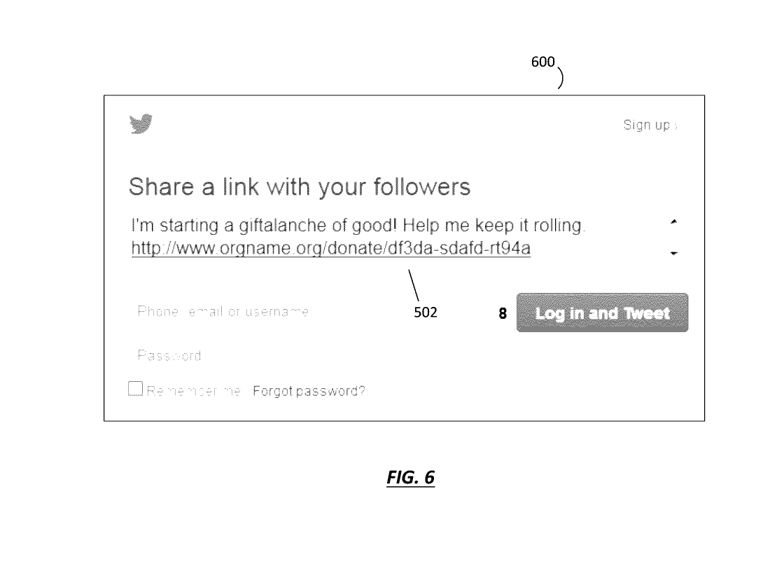

FIG. 4 is an illustration of a webpage containing a donation form. According to an embodiment, a webpage 400 contains a donation form 406 including gift amount, billing address and payment details. Webpage 400 is located by initiating a request in a web or mobile browser to URL 402. URL 402 contains a root GUID. A root GUID is the unique identifier for webpage 400, and is used by the database to define relationships to any branch GUIDs created therefrom. A donor may complete the inputs on webpage 400 and submit the data to an application server for processing, as described above. FIG. 5 is an illustration of a gift confirmation screen 500, which according to an embodiment is the screen displayed to the user after submitting the form data. Confirmation screen 500 contains a confirmation of the transaction and the gift details; as well as a link containing a URL 502 to access a branch donation page to share over email or social platforms. Link 502 contains a branch GUID, as described above, such that the system may track donations made through link 502 and associate them with the donor who shared the link. Confirmation screen 500 may use an API to connect to various social platforms. FIG. 6 is an illustration of a social platform share screen according to an embodiment. The donor may click a share link on confirmation screen 500 and be directed to a social sharing prompt, containing link 502. The donor may share link 502 through his or her social network on the desired social platform.

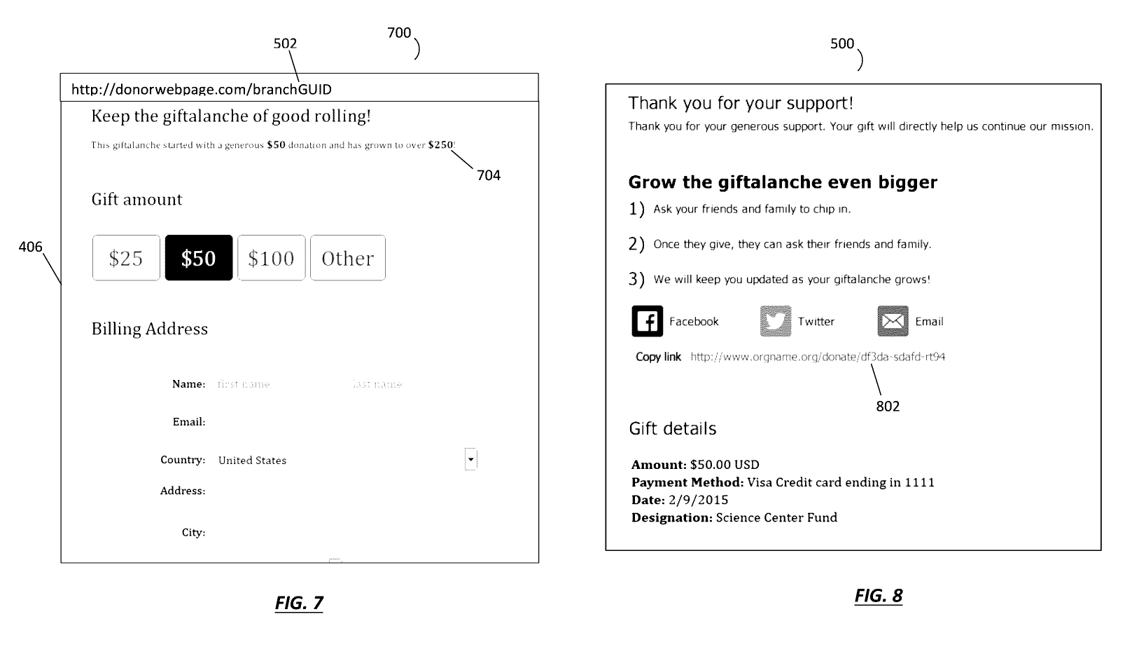

FIG. 7 is an illustration of a branch donor webpage 700, according to an embodiment. Branch donor webpage 700 is accessed from link 502, which contains the branch GUID in the URL. Webpage 700 communicates with the database to display the gift amount associated with the root GUID, and the aggregate of all gifts sharing a branch relationship with the root GUID 704. Webpage 700 contains donation form 406 including gift amount, billing address and payment details. The branch donor completes the inputs on webpage 700 and submits the data. Upon completion of transaction, branch donor is directed to confirmation screen 500. Confirmation screen 500 contains a sub-branch link 802, containing a new GUID associated with the branch donor.

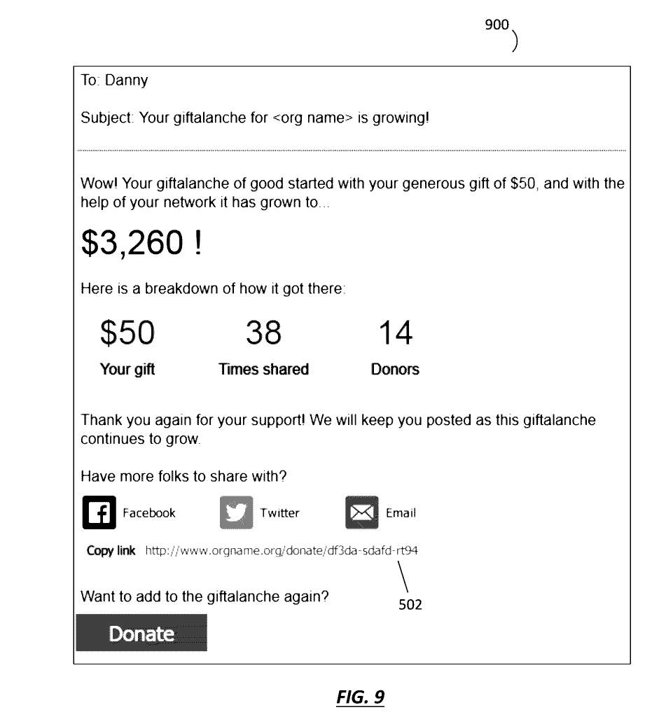

FIG. 9 is an illustration of a donor influence report 900, according to an embodiment. Influence report 900 may be assembled as an email to the donor, and may contain data such as the original gift amount, number of times the branch link was shared, number of donations made from the link, and total amount of funds raised from donations collected through the link. In this example, link 502 was shared 38 times and 14 people made donations through the donation form on the webpage, totaling $3,260.

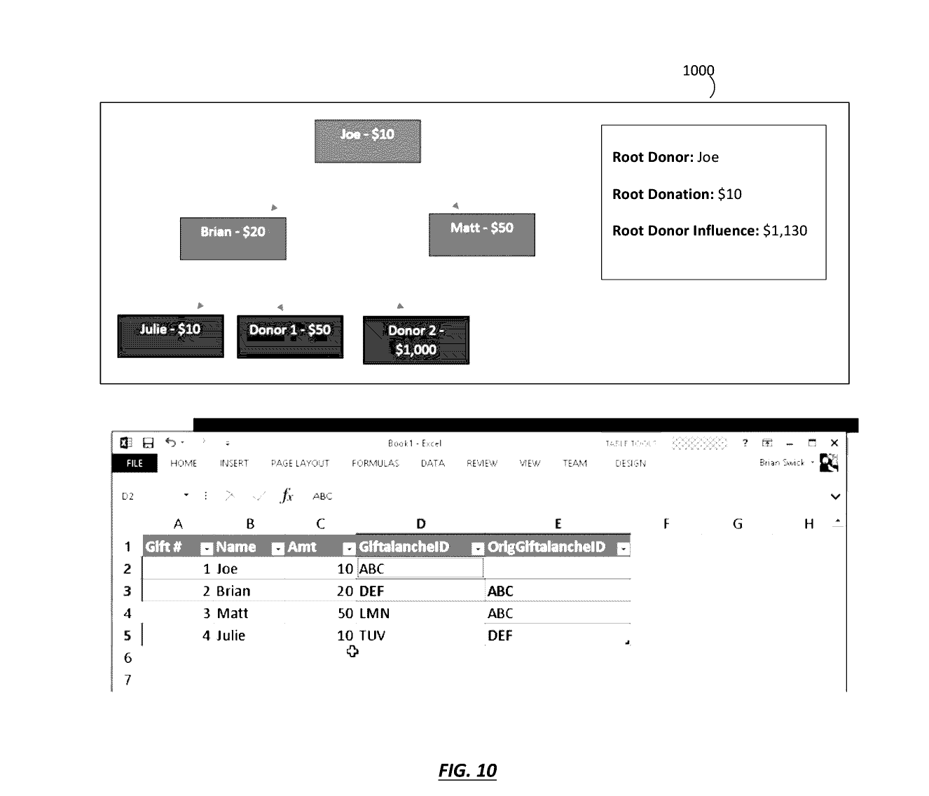

FIG. 10 is a schematic diagram of a donor influence map 1000, illustrating relationships between donors in the database. In this illustration, Joe is the root donor and is associated with a GUID of “ABC” in the database. Joe shared a link containing the GUID with Brian and Matt, who made gifts of $20 and $50 respectively. Brian and Matt have an originating or root GUID of “ABC,” which defines their relationship to Joe in the database. Brian and Matt also have their own unique GUIDs in the database to track access and engagement with their unique links. Brian shares his unique link with Julie, Donor 1, and Donor 2; whom each make respective gifts of $10, $50, and $1,000, and are each assigned unique GUIDs of their own. Brian's GUID becomes the root GUID for each of these transactions, such that Brian's influence can be tracked while also rolling up Joe's aggregate influence. In this example, Joe's aggregate influence as a result of link sharing is $1,130, despite only making a donation of $10.

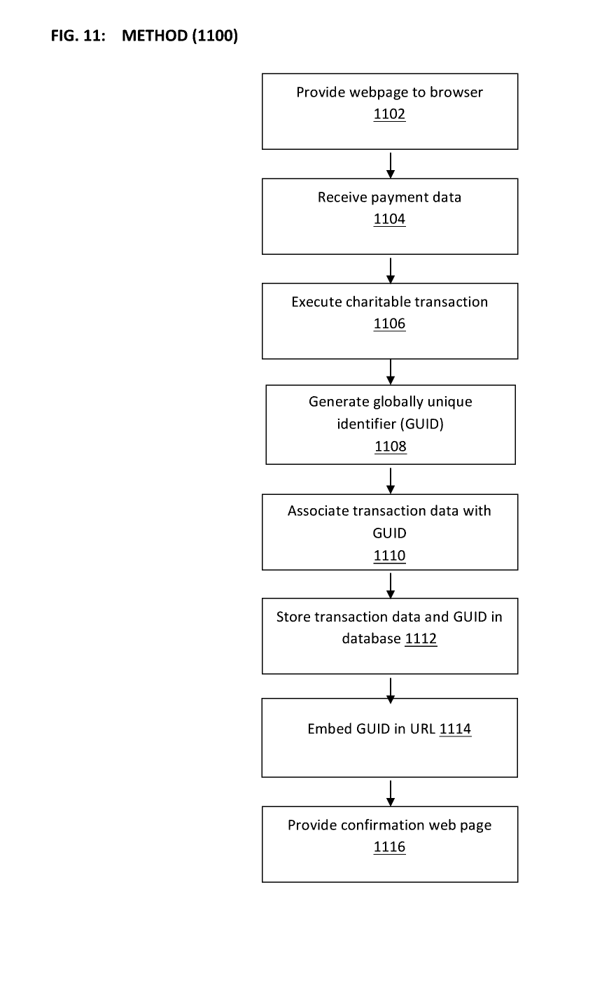

FIG. 11 is a process flow diagram of a method of embedding a globally unique identifier in a web form for the purpose of tracking relationships between charitable transactions across a network, in accordance with various embodiments. The method comprises, at block 1102, providing a web page to a web browser in response to a request from a donor device through a computer system having an application server and/or web server. The web page is associated with a charitable fundraising campaign and contains one or more HTML form elements to input payment data from the donor device. The donor may input payment data and submit the data through the webpage on the donor device. The web browser could include, but are not necessarily limited to, Microsoft Internet Explorer, Mozilla Firefox and Google Chrome. At block 1104, the application server receives payment data submitted from the donor device through the web page via an HTTP transfer protocol. At block 1106, the application server transmits payment data to a payment gateway, and the payment gateway executing a transaction for a charitable donation and provisioning transaction data to the application server. At block 1108, the computer system generates a globally unique identifier. The computer system may use an internal or external application to generate the GUID under various implementations of the universally unique identifier (UUID) standard. At block 1110, the computer system associates the transaction data with the globally unique identifier. At block 1112, the computer system provisions the GUID and the transaction data to the transaction database. The transaction database stores the transaction as a root node and assigns the globally unique identifier as a primary key to the root node. As used herein, the term “providing,” with respect to a database, can include one or more of several operations, including without limitation creating the database, maintaining (e.g., compacting, etc.) the database, making the database available for queries, storing the database (e.g., on a computer readable medium), and/or the like. At block 1114, the application server embeds the globally unique identifier in a uniform resource locator that enables access to a webpage associated with the charitable fundraising campaign and contains one or more form elements to input payment data from a branch donor. At block 1116, the computer system provides a web page to the donor device containing a transaction confirmation and the uniform resource locator for sharing with branch donors over a network.

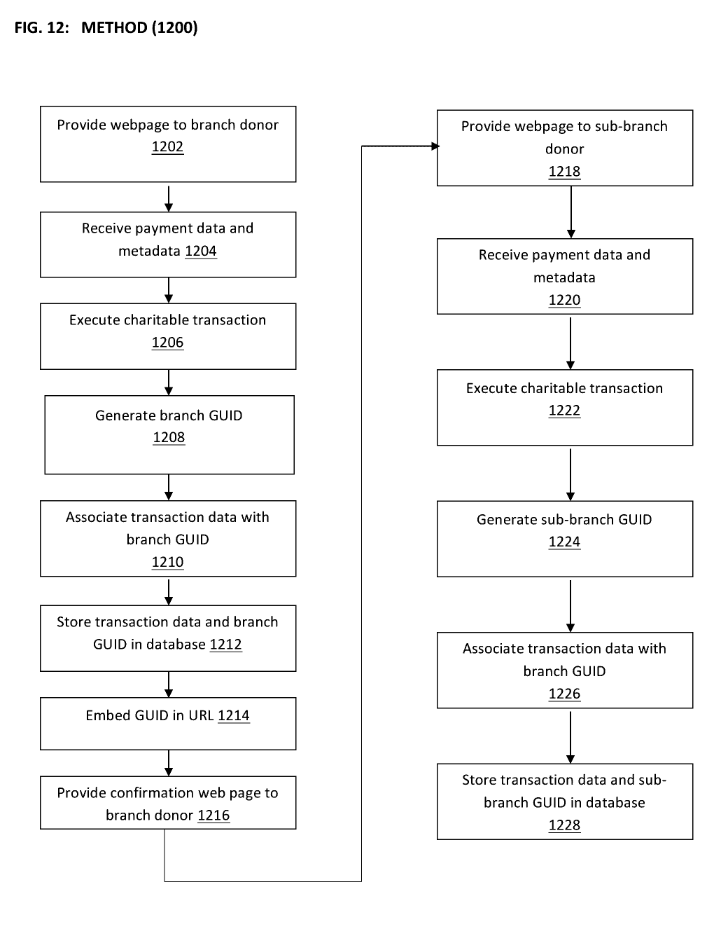

FIG. 12 is a process flow diagram of a method of embedding a globally unique identifier in a web form for the purpose of tracking relationships between charitable transactions across a network, continued from FIG. 11, in accordance with various embodiments. At block 1202, the computer system provides a web page containing the embedded GUID to a web browser in response to a request from the branch donor device. The web page contains elements associated with the charitable fundraising campaign and contains one or more form elements to input payment data from the branch donor device. The branch donor may input payment data and submit the data through the webpage on the branch donor device. At block 1204, the application server receives payment data and metadata submitted from the branch donor device through the web page. At block 1206, the application server transmits the payment data to a payment gateway, and the payment gateway executes a transaction for a charitable donation and provisions transaction data to the application server.

At block 1208, the computer system generates a branch globally unique identifier using the GUID generator. At block 1210, the computer system associates the transaction data with the globally unique identifier and the branch globally unique identifier. At block 1212, the computer system stores in the transaction database, the transaction data, the globally unique identifier and the branch globally unique identifier. The transaction database stores the transaction as a child node to the root node, as described in FIG. 11, and assigns the branch globally unique identifier as a foreign key to the child node. At block 1214, the application server embeds the branch globally unique identifier in a uniform resource locator, the uniform resource locator configured to access the webpage associated with the charitable fundraising campaign. At block 1216, the computer system provides a web page to the branch donor device, the web page containing a transaction confirmation and the uniform resource locator.

At block 1218, the computer system provides a web page to a plurality of sub-branch donor devices, in which the web page contains metadata containing the branch globally unique identifier, and one or more form elements to input payment data from the plurality of sub-branch donor devices. At block 1220, the application server receives the payment data and metadata submitted from the plurality of sub-branch donor devices through the web page via an HTTP protocol from the sub-branch donor devices. At block 1222 the application server executes a plurality of transactions for charitable donations associated to the sub-branch web page submissions, and provisions transaction data to the application server for the plurality of transactions. At block 1224, the computer system generates a sub-branch globally unique identifier for each transaction in the plurality of transactions using the GUID generator. At block 1226, the computer system associates the transaction data with the branch globally unique identifier and the sub-branch globally unique identifier for each transaction in the plurality of transactions. At block 1228, the computer system stores in the transaction database the transaction data for each transaction in the plurality of transactions, the branch globally unique identifier and the sub-branch globally unique identifier. The transaction database stores each transaction in the plurality of transactions as a descendant node to the child node and assigns the sub-branch globally unique identifier as a foreign key to the descendant node.

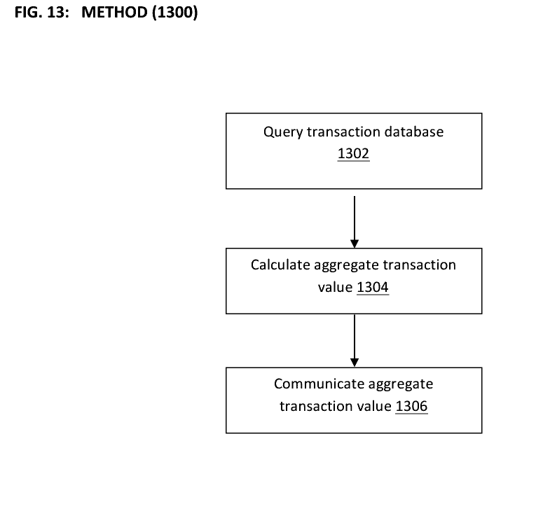

FIG. 13 is a process flow diagram of a method of querying a database to determine an aggregate transaction value across selected nodes, continued from FIG. 12, in accordance with various embodiments. At block 1302, the application server queries the transaction database to aggregate transaction data across child nodes and descendant nodes of the root node, and calculates an aggregate transaction value across each node at block 1304. At block 1306, the computer system communicates the aggregate transaction value for a specific node to one or more social network web platforms or through an email server to one or more emails associated with the charitable campaign.

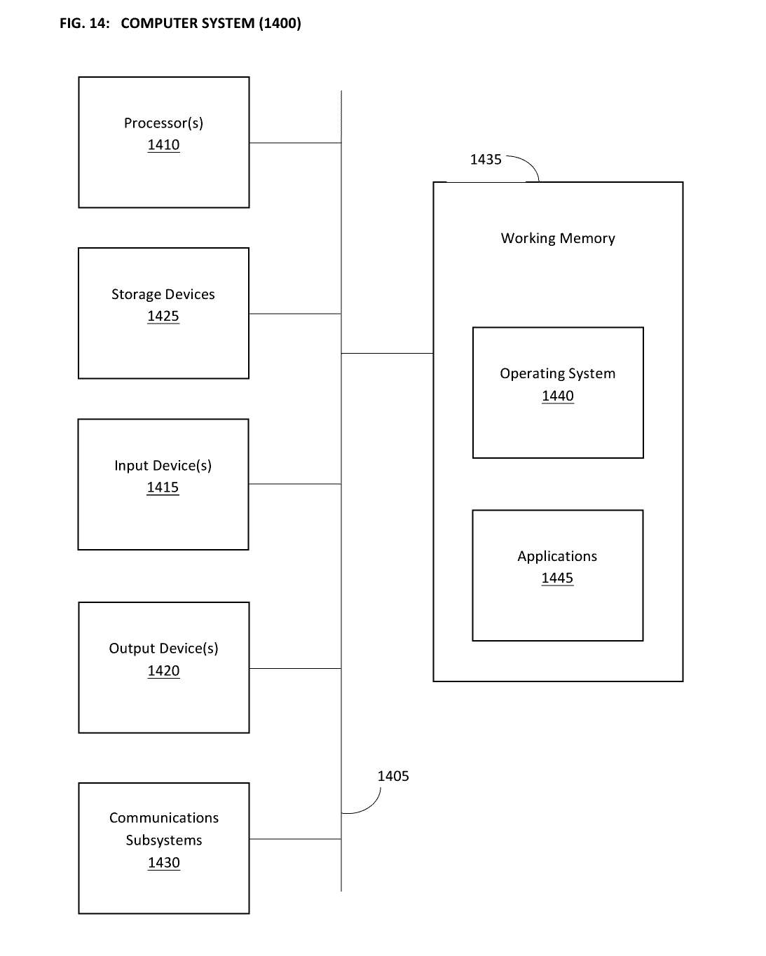

FIG. 14 provides a schematic illustration of one embodiment of a computer system 1400 that can perform the methods provided by various other embodiments, as described herein, and/or can function as the branch donor client 14 or application server 102 described above. It should be noted that FIG. 14 is meant only to provide a generalized illustration of various components, of which one or more (or none) of each may be utilized as appropriate. FIG. 14, therefore, broadly illustrates how individual system elements may be implemented in a relatively separated or relatively more integrated manner.

The computer system 1400 is shown comprising hardware elements that can be electrically coupled via a bus 1405 (or may otherwise be in communication, as appropriate). The hardware elements may include one or more processors 1410, including without limitation one or more general-purpose processors and/or one or more special-purpose processors (such as digital signal processing chips, graphics acceleration processors, and/or the like); one or more input devices 1415, which can include without limitation a mouse, a keyboard and/or the like; and one or more output devices 1420, which can include without limitation a display device, a printer and/or the like.

The computer system 1400 may further include (and/or be in communication with) one or more storage devices 1425, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1400 might also include a communications subsystem 1430, which can include without limitation a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 1430 may permit data to be exchanged with a network (such as the network described below, to name one example), with other computer systems, and/or with any other devices described herein. In many embodiments, the computer system 1400 will further comprise a working memory 1435, which can include a RAM or ROM device, as described above.

The computer system 1400 also may comprise software elements, shown as being currently located within the working memory 1435, including an operating system 1440, device drivers, executable libraries, and/or other code, such as one or more application programs 1445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 1425 described above. In some cases, the storage medium might be incorporated within a computer system, such as the system 1400. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 800 and/or might take the form of source and/or installable code, which, upon compilation and/or installation on the computer system 1400 (e.g., using any of a variety of generally available compilers, installation programs, compression/decompression utilities, etc.) then takes the form of executable code.

As mentioned above, in one aspect, some embodiments may employ a computer system (such as the computer system 1400) to perform methods in accordance with various embodiments of the invention. According to a set of embodiments, some or all of the procedures of such methods are performed by the computer system 1400 in response to processor 1410 executing one or more sequences of one or more instructions (which might be incorporated into the operating system 1440 and/or other code, such as an application program 1445) contained in the working memory 1435. Such instructions may be read into the working memory 1435 from another computer readable medium, such as one or more of the storage device(s) 1425. Merely by way of example, execution of the sequences of instructions contained in the working memory 1435 might cause the processor(s) 1410 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 1400, various computer readable media might be involved in providing instructions/code to processor(s) 1410 for execution and/or might be used to store and/or carry such instructions/code (e.g., as signals). In many implementations, a computer readable medium is a non-transitory, physical and/or tangible storage medium. Such a medium may take many forms, including but not limited to, non-volatile media, volatile media, and transmission media. Non-volatile media includes, for example, optical and/or magnetic disks, such as the storage device(s) 1425. Volatile media includes, without limitation, dynamic memory, such as the working memory 1435. Transmission media includes, without limitation, coaxial cables, copper wire and fiber optics, including the wires that comprise the bus 1405, as well as the various components of the communication subsystem 1430 (and/or the media by which the communications subsystem 1430 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 1410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1400. These signals, which might be in the form of electromagnetic signals, acoustic signals, optical signals and/or the like, are all examples of carrier waves on which instructions can be encoded, in accordance with various embodiments of the invention.

The communications subsystem 1430 (and/or components thereof) generally will receive the signals, and the bus 1405 then might carry the signals (and/or the data, instructions, etc. carried by the signals) to the working memory 1435, from which the processor(s) 1405 retrieves and executes the instructions. The instructions received by the working memory 1435 may optionally be stored on a storage device 1425 either before or after execution by the processor(s) 1410.

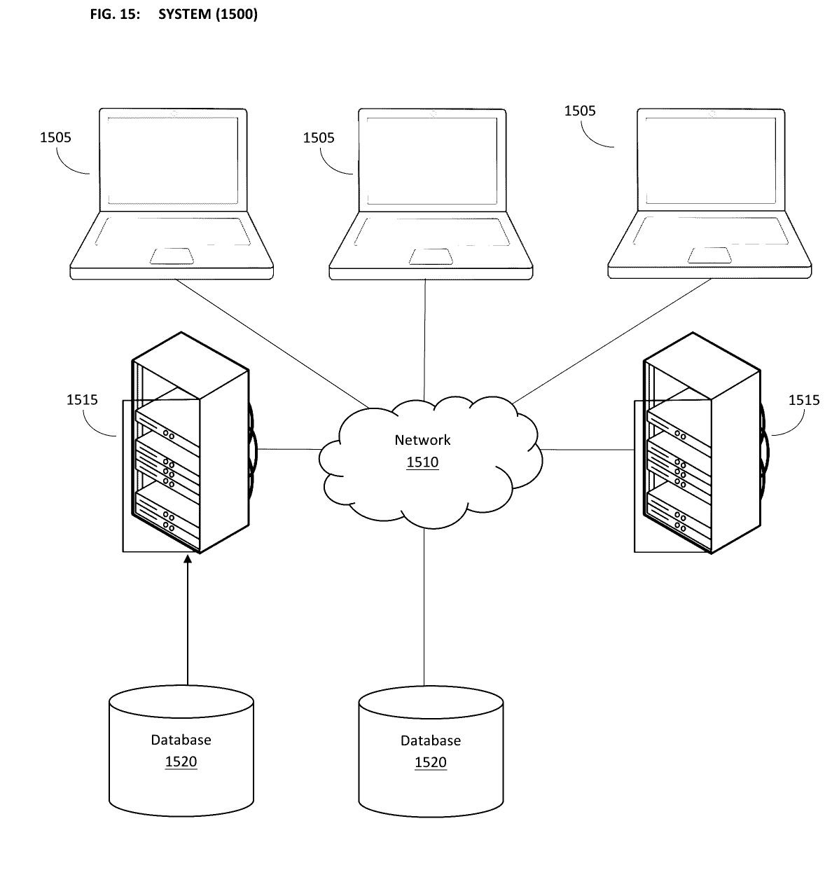

As noted above, a set of embodiments comprises systems for recovery of information from commercial web portals. FIG. 15 illustrates a schematic diagram of a system 1500 that can be used in accordance with one set of embodiments. The system 1500 can include one or more user computers 1505. A donor computer 1505 can be a general purpose personal computer (including, merely by way of example, desktop computers, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A donor computer 1505 can also have any of a variety of applications, including one or more applications configured to perform methods provided by various embodiments (as described above, for example), as well as one or more office applications, database client and/or server applications, and/or web browser applications. Alternatively, a donor computer 1505 can be any other electronic device, such as a thin-client computer, Internet-enabled mobile telephone, and/or personal digital assistant, capable of communicating via a network (e.g., the network 1510 described below) and/or of displaying and navigating web pages or other types of electronic documents. Although the exemplary system 1500 is shown with three user computers 1505, any number of user computers can be supported.

Certain embodiments operate in a networked environment, which can include a network 1510. The network 1510 can be any type of network familiar to those skilled in the art that can support data communications using any of a variety of commercially-available (and/or free or proprietary) protocols, including without limitation TCP/IP, SNA™, IPX™, AppleTalk™, and the like. Merely by way of example, the network 1510 can include a local area network (“LAN”), including without limitation a fiber network, an Ethernet network, a Token-Ring™ network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments can also include one or more server computers 1515. Each of the server computers 1515 may be configured with an operating system, including without limitation any of those discussed above, as well as any commercially (or freely) available server operating systems. Each of the servers 1515 may also be running one or more applications, which can be configured to provide services to one or more clients 1505 and/or other servers 1515. Merely by way of example, in some cases, one or more servers 1515 might be configured to operate a core system of an donor influence tracking system, while other servers 1515 (or clients) can be configured to operate remote control modules, as described above. In some instances, a plurality of servers 1515 (i.e., processors) might be configured to operate in a grid or “cloud” configuration, in which computing resources (memory, processors, etc.) are shared as a pool, on which different applications (e.g., software agents) can draw.

In some cases, one of the servers 1515 may be a web server, which can be used, merely by way of example, to process requests for web pages or other electronic documents from user computers 1505. The web server can also run a variety of server applications, including HTTP servers, FTP servers, CGI servers, database servers, Java servers, and the like. In some embodiments of the invention, the web server may be configured to serve web pages that can be operated within a web browser on one or more of the donor computers 1505 to perform methods of the invention.

The server computers 1515, in some embodiments, might include one or more application servers, which can be configured with one or more applications accessible by a client running on one or more of the client computers 1505 and/or other servers 1515. Merely by way of example, the server(s) 1515 can be one or more general purpose computers capable of executing programs or scripts in response to the user computers 1505 and/or other servers 1515, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle™, Microsoft™, Sybase™, IBM™ and the like, which can process requests from clients (including, depending on the configuration, dedicated database clients, API clients, web browsers, etc.) running on a user computer 1505 and/or another server 1515. In some embodiments, an application server can create web pages dynamically for displaying the information in accordance with various embodiments. Data provided by an application server may be formatted as one or more web pages (comprising HTML, JavaScript, etc., for example) and/or may be forwarded to a user computer 1505 via a web server (as described above, for example). Similarly, a web server might receive web page requests and/or input data from a user computer 1505 and/or forward the web page requests and/or input data to an application server. In some cases, a web server may be integrated with an application server.

In accordance with further embodiments, one or more servers 1515 can function as a file server and/or can include one or more of the files (e.g., application code, data files, etc.) necessary to implement various disclosed methods, incorporated by an application running on a user computer 1505 and/or another server 1515. Alternatively, as those skilled in the art will appreciate, a file server can include all necessary files, allowing such an application to be invoked remotely by a user computer 1505 and/or server 1515.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 1520, such as those described above. The location of the database(s) 1520 is discretionary: merely by way of example, a database 1520 a might reside on a storage medium local to (and/or resident in) a server 1515 a (and/or a user computer 1505). Alternatively, a database 1520 b can be remote from any or all of the computers 1505, 1515, so long as it can be in communication (e.g., via the network 1510) with one or more of these. In a particular set of embodiments, a database 1520 can reside in a storage-area network (“SAN”) familiar to those skilled in the art. (Likewise, any necessary files for performing the functions attributed to the computers 1505, 1515 can be stored locally on the respective computer and/or remotely, as appropriate.) In one set of embodiments, the database 1520 can be a relational database, such as an Oracle database, that is adapted to store, update, and retrieve data in response to SQL-formatted commands. The database might be controlled and/or maintained by a database server, as described above, for example.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method of embedding a globally unique identifier in a web form for the purpose of tracking relationships between charitable transactions across a network, the method comprising:
providing, with a computer system, a web page to a web browser in response to a request from a donor device, the web page being associated with a charitable fundraising campaign and containing one or more form elements to input payment data from the donor device, the computer system having an application server and a transaction database;
receiving, with the application server, payment data submitted from the donor device through the web page;
transmitting, with the application server, payment data to a payment gateway, the payment gateway executing a transaction for a charitable donation and provisioning transaction data to the application server;
generating, with the computer system, a globally unique identifier;
associating, with the computer system, the transaction data with the globally unique identifier;
storing, with the computer system and in the transaction database, the transaction data and the globally unique identifier, the transaction database storing the transaction as a root node and assigning the globally unique identifier as a primary key to the root node;
embedding, with the application server, the globally unique identifier in a uniform resource locator, the uniform resource locator configured to access a webpage associated with the charitable fundraising campaign and containing one or more form elements to input payment data from a branch donor; and,
providing, with the computer system, a web page to the donor device, the web page containing a transaction confirmation and the uniform resource locator.

2. The method of claim 1 further comprising providing, with the computer system, a web page to a branch donor device, the web page having metadata containing the globally unique identifier.

3. The method of claim 2 further comprising:
providing, with the computer system, a web page to a web browser in response to a request from the branch donor device, the web page being associated with the charitable fundraising campaign and containing one or more form elements to input payment data from the branch donor device;
receiving, with the application server, payment data and metadata submitted from the branch donor device through the web page; and,
transmitting, with the application server, payment data to a payment gateway, the payment gateway executing a transaction for a charitable donation and provisioning transaction data to the application server.

4. The method of claim 3 further comprising:
generating, with the computer system, a branch globally unique identifier;
associating, with the computer system, the transaction data with the globally unique identifier and the branch globally unique identifier;
storing, with the computer system and in the transaction database, the transaction data, the globally unique identifier and the branch globally unique identifier, the transaction database storing the transaction as a child node to the root node and assigning the branch globally unique identifier as a foreign key to the child node.

5. The method of claim 4 further comprising:
embedding, with the application server, the branch globally unique identifier in a uniform resource locator, the uniform resource locator configured to access the webpage associated with the charitable fundraising campaign; and,
providing, with the computer system, a web page to the branch donor device, the web page containing a transaction confirmation and the uniform resource locator.

6. The method of claim 5 further comprising providing, with the computer system, a web page to a plurality of sub-branch donor devices, the web page having metadata containing the branch globally unique identifier, the web page containing one or more form elements to input payment data from the plurality of sub-branch donor devices.

7. The method of claim 6 further comprising:
receiving, with the application server, payment data and metadata submitted from the plurality of sub-branch donor devices through the web page;
executing, with the application server, a plurality of transactions for charitable donations and provisioning transaction data to the application server for the plurality of transactions;
generating, with the computer system, a sub-branch globally unique identifier for each transaction in the plurality of transactions;
associating, with the computer system, the transaction data with the branch globally unique identifier and the sub-branch globally unique identifier for each transaction in the plurality of transactions; and,
storing, with the computer system and in the transaction database, the transaction data for each transaction in the plurality of transactions, the branch globally unique identifier and the sub-branch globally unique identifier, the transaction database storing each transaction in the plurality of transactions as a descendant node to the child node and assigning the sub-branch globally unique identifier as a foreign key to the descendant node.

8. The method of claim 7 further comprising querying, with the application server, the transaction database to aggregate transaction data across child nodes and descendant nodes of the root node, and calculating an aggregate transaction value across each node.

9. The method of claim 8 further comprising communicating, with the computer system, the aggregate transaction value for a specific node to a social network web platform.

10. A computer system comprising:
one or more processors, the one or more processors defining an application server;
a transaction database operatively associated with at least one of the one or more processors;
a set of instructions executable by at least one of the one or more processors, to cause the at least one of the one or more processors to perform one or more operations, the set of instructions comprising:
instructions for providing a web page to a web browser in response to a request from a donor device, the web page being associated with a charitable fundraising campaign and containing one or more form elements to input payment data from the donor device;
instructions for receiving payment data submitted from the donor device through the web page;
instructions for transmitting payment data to a payment gateway, the payment gateway executing a transaction for a charitable donation and provisioning transaction data to the application server;
instruction for generating, with a globally unique identifier generation engine, a globally unique identifier;
instructions for associating the transaction data with the globally unique identifier;
instructions for storing in the transaction database, the transaction data and the globally unique identifier, the transaction database storing the transaction as a root node and assigning the globally unique identifier as a primary key to the root node;
instructions for embedding, with the application server, the globally unique identifier in a uniform resource locator, the uniform resource locator configured to access a webpage associated with the charitable fundraising campaign and containing one or more form elements to input payment data from a branch donor; and,
instructions for communicating a web page to the donor device, the web page containing a transaction confirmation and the uniform resource locator.

11. The computer system of claim 10 wherein the set of instructions further comprises:
instructions for providing, with the computer system, a web page to a web browser in response to a request from the branch donor device, the web page being associated with the charitable fundraising campaign and containing one or more form elements to input payment data from the branch donor device and metadata containing the globally unique identifier;
instructions for receiving, with the application server, payment data and metadata submitted from the branch donor device through the web page; and,
instructions for transmitting, with the application server, payment data to a payment gateway, the payment gateway executing a transaction for a charitable donation and provisioning transaction data to the application server.

12. The computer system of claim 11 wherein the set of instructions further comprises:
instructions for generating, with the computer system, a branch globally unique identifier;
instructions for associating, with the computer system, the transaction data with the globally unique identifier and the branch globally unique identifier; and,
instructions for storing, with the computer system and in the transaction database, the transaction data, the globally unique identifier and the branch globally unique identifier, the transaction database storing the transaction as a child node to the root node and assigning the branch globally unique identifier as a foreign key to the child node.

13. The computer system of claim 12 wherein the set of instructions further comprises instructions for embedding, with the application server, the branch globally unique identifier in a uniform resource locator, the uniform resource locator configured to access the webpage associated with the charitable fundraising campaign; and,
instructions for providing, with the computer system, a web page to the branch donor device, the web page containing a transaction confirmation and the uniform resource locator.

14. The computer system of claim 13 wherein the set of instructions further comprises instructions for providing, with the computer system, a web page to a plurality of sub-branch donor devices, the web page having metadata containing the branch globally unique identifier, the web page containing one or more form elements to input payment data from the plurality of sub-branch donor devices.

15. The computer system of claim 14 wherein the set of instructions further comprises instructions for receiving, with the application server, payment data and metadata submitted from the plurality of sub-branch donor devices through the web page;
instructions for executing, with the application server, a plurality of transactions for charitable donations and provisioning transaction data to the application server for the plurality of transactions;
instructions for generating, with the computer system, a sub-branch globally unique identifier for each transaction in the plurality of transactions;
instructions for associating, with the computer system, the transaction data with the branch globally unique identifier and the sub-branch globally unique identifier for each transaction in the plurality of transactions; and,
instructions for storing, with the computer system and in the transaction database, the transaction data for each transaction in the plurality of transactions, the branch globally unique identifier and the sub-branch globally unique identifier, the transaction database storing each transaction in the plurality of transactions as a descendant node to the child node and assigning the sub-branch globally unique identifier as a foreign key to the descendant node.

16. An apparatus comprising:
one or more processors, the one or more processors defining an application server;
a transaction database operatively associated with at least one of the one or more processors;
a non-transitory computer readable medium having stored thereon a set of instructions executable by at least one of the one or more processors, to cause the at least one of the one or more processors to perform one or more operations, the set of instructions comprising:
one or more processors, the one or more processors defining an application server;
a transaction database operatively associated with at least one of the one or more processors;
a set of instructions executable by at least one of the one or more processors, to cause the at least one of the one or more processors to perform one or more operations, the set of instructions comprising:
instructions for providing a web page to a web browser in response to a request from a donor device, the web page being associated with a charitable fundraising campaign and containing one or more form elements to input payment data from the donor device;
instructions for receiving payment data submitted from the donor device through the web page;
instructions for transmitting payment data to a payment gateway, the payment gateway executing a transaction for a charitable donation and provisioning transaction data to the application server;
instruction for generating, with a globally unique identifier generation engine, a globally unique identifier;
instructions for associating the transaction data with the globally unique identifier;
instructions for storing in the transaction database, the transaction data and the globally unique identifier, the transaction database storing the transaction as a root node and assigning the globally unique identifier as a primary key to the root node;
instructions for embedding, with the application server, the globally unique identifier in a uniform resource locator, the uniform resource locator configured to access a webpage associated with the charitable fundraising campaign and containing one or more form elements to input payment data from a branch donor; and,
instructions for communicating a web page to the donor device, the web page containing a transaction confirmation and the uniform resource locator.

17. The apparatus of claim 16 wherein the set of instructions further comprises instructions for providing, with the computer system, a web page to a web browser in response to a request from the branch donor device, the web page being associated with the charitable fundraising campaign and containing one or more form elements to input payment data from the branch donor device and metadata containing the globally unique identifier;
instructions for receiving, with the application server, payment data and metadata submitted from the branch donor device through the web page; and,
instructions for transmitting, with the application server, payment data to a payment gateway, the payment gateway executing a transaction for a charitable donation and provisioning transaction data to the application server.

18. The apparatus of claim 17 wherein the set of instructions further comprises instructions for generating, with the computer system, a branch globally unique identifier;
instructions for associating, with the computer system, the transaction data with the globally unique identifier and the branch globally unique identifier; and,
instructions for storing, with the computer system and in the transaction database, the transaction data, the globally unique identifier and the branch globally unique identifier, the transaction database storing the transaction as a child node to the root node and assigning the branch globally unique identifier as a foreign key to the child node.

19. The apparatus of claim 18 wherein the set of instructions further comprises instructions for receiving, with the application server, payment data and metadata submitted from a plurality of sub-branch donor devices through the web page;
instructions for executing, with the application server, a plurality of transactions for charitable donations and provisioning transaction data to the application server for the plurality of transactions;
instructions for generating, with the computer system, a sub-branch globally unique identifier for each transaction in the plurality of transactions;
instructions for associating, with the computer system, the transaction data with the branch globally unique identifier and the sub-branch globally unique identifier for each transaction in the plurality of transactions; and,
instructions for storing, with the computer system and in the transaction database, the transaction data for each transaction in the plurality of transactions, the branch globally unique identifier and the sub-branch globally unique identifier, the transaction database storing each transaction in the plurality of transactions as a descendant node to the child node and assigning the sub-branch globally unique identifier as a foreign key to the descendant node.

20. The apparatus of claim 19 wherein the set of instructions further comprises instructions for querying, with the application server, the transaction database to aggregate transaction data across child nodes and descendant nodes of the root node, and calculating an aggregate transaction value across each node.
